(19) United States
(12) Patent Application Publication
(10) Pub. No.: US 2016/0125084 A1
(43) Pub. Date: May 5, 2016

(54) ELECTRONIC DEVICE, SEARCH SERVER, AND DATA SEARCH METHOD THEREFOR

(71) Applicant: Samsung Electronics Co., Ltd., Gyeonggi-do (DE)

(72) Inventors: Seung Yeol Yoo, Gyeonggi-do (KR); Brahmananda Sapkota, Seoul (KR); Dae Keun Seo, Seoul (KR); Henry Genet, Seoul (KR)

(21) Appl. No.: 14/929,222

(22) Filed: Oct. 30, 2015

(30) Foreign Application Priority Data
Oct. 30, 2014 (KR) 10-2014-0149487

(51) Int. Cl. G06F 17/30

(52) U.S. Cl. CPC G06F 17/30864; G06F 17/30321

(57) ABSTRACT

An electronic device, a search server, and a data search method are provided herein. The search server includes a communication device configured to receive a plurality of indices for setting a search item. The search server also includes a memory configured to store an index map in which link relations among a plurality of indices are defined. The search server further includes a controller configured to detect at least one path, including the plurality of received indices, using the index map and to set the search item according to the at least one detected path.

### CROSS-REFERENCE TO RELATED APPLICATION AND CLAIM OF PRIORITY

The present application is related to and claims benefit under 35 U.S.C. §119(a) of a Korean patent application filed on Oct. 30, 2014 in the Korean Intellectual Property Office and assigned Serial number 10-2014-0149487, the entire disclosure of which is hereby incorporated by reference.

### TECHNICAL FIELD

The present disclosure relates to an electronic device for searching for semantic-based data, a search server, and a data search method therefor.

### BACKGROUND

Information values have become more important than material values as the 21^{th} century has been called an information-oriented age. Recently, because a quantity, period, and form in which data are generated has been increased as digital environments have been expanded, big data, which are difficult to be collected, stored, searched for, and analyzed by conventional methods, have become important as a social issue. Therefore, a process of processing and analyzing data and generating significant data has become more and more important. Also, a process of providing analyzed data to users in a more efficient way has been gradually important.

### SUMMARY

To address the above-discussed deficiencies, it is a primary object to provide at least the advantages described below. Accordingly, an aspect of the present disclosure is to provide an electronic device for setting a search item which is not previously defined and dynamically searching for data, a search server, and a data search method therefor.

In a first embodiment, a search server is provided. The search server includes a communication module configured to receive a plurality of indices for setting a search item. The search server also includes a memory configured to store an index map in which link relations among a plurality of indices are defined. The search server further includes a control module configured to detect at least one path, including the plurality of received indices, using the index map and to set the search item according to the at least one detected path.

In a second embodiment, a data search method is provided. The data search method includes receiving a plurality of indices for setting a search item. The data search method also includes detecting at least one path, including the plurality of received indices, using the index map in which link relations among a plurality of indices are defined. The data search method further includes setting the search item according to the at least one detected path.

In a third embodiment, an electronic device is provided. The electronic device includes an input module configured to receive a plurality of indices for setting a search item. The electronic device also includes a memory configured to store an index map in which link relations among a plurality of indices are defined. The electronic device further includes a control module configured to detect at least one path, including the plurality of received indices, using the index map and to set the search item according to the at least one detected path.

In a fourth embodiment, a data search method is provided. The data search method includes receiving a plurality of indices for setting a search item. The data search method also includes detect at least one path, including the plurality of received indices, using an index map in which link relations among a plurality of indices are defined. The data search method further includes setting the search item according to the at least one detected path.

Other aspects, advantages, and salient features of the disclosure will become apparent to those skilled in the art from the following detailed description, which, taken in conjunction with the annexed drawings, discloses various embodiments of the present disclosure.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 is a drawing illustrating an example configuration of a search system according to this disclosure;

FIG. 2 is a signal sequence diagram illustrating an example data search method of a search system according to this disclosure;

FIG. 3 is a signal sequence diagram illustrating an example data search method of a search system according to this disclosure;

FIG. 4 is a block diagram illustrating an example configuration of an electronic device according to this disclosure;

FIG. 5 is a drawing illustrating an example index map according to this disclosure;

FIG. 6 is a drawing illustrating an example display screen according to this disclosure;

FIGS. 7A and 7B are drawings illustrating an example display screen according to this disclosure;

FIG. 8 is a block diagram illustrating an example configuration of a search server according to this disclosure;

FIG. 9 is a flowchart illustrating an example data search method of an electronic device according to this disclosure; and

FIG. 10 is a flowchart illustrating an example data search method of a search server according to this disclosure.

Throughout the drawings, it should be noted that like reference numbers are used to depict the same or similar elements, features, and structures.

### DETAILED DESCRIPTION

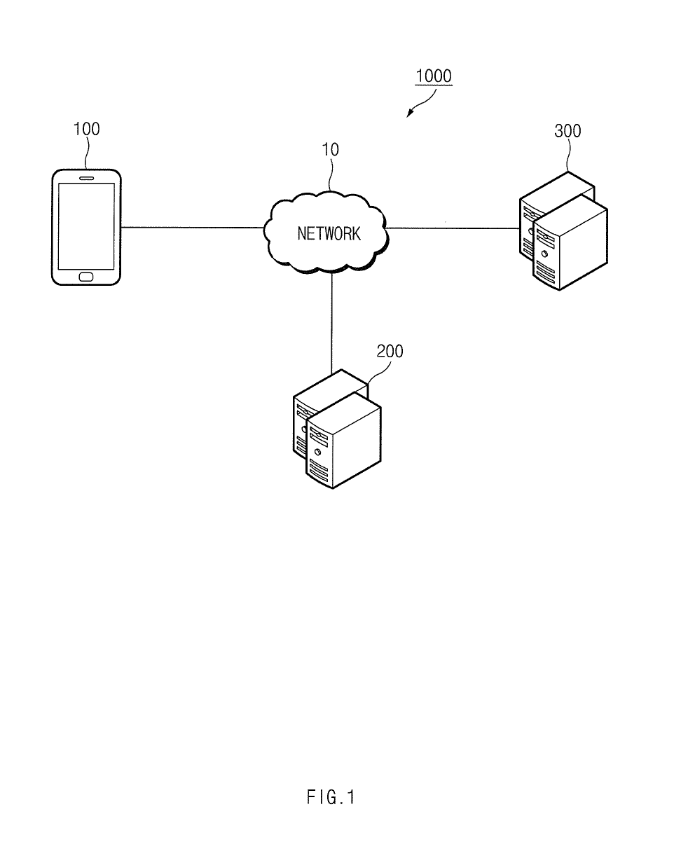

FIGS. 1 through 10, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged electronic device. Hereinafter, the present disclosure is described with reference to the accompanying drawings. However, the present disclosure is not intended to be limited to the specific embodiments, and it is understood that it should include various modifications, equivalents, and/or alternatives within the scope and technical range of the present disclosure. With respect to the descriptions of the drawings, like reference numerals refer to like elements.

In the disclosure disclosed herein, the expressions “have”, “may have”, “include” and “comprise”, or “may include” and “may comprise” used herein indicate existence of corresponding features (e.g., elements such as numeric values, functions, operations, or components) but do not exclude presence of additional features.

In the disclosure disclosed herein, the expressions “A or B”, “at least one of A or/and B”, or “one or more of A or/and B”, and the like used herein may include any and all combinations of one or more of the associated listed items. For example, the term “A or B”, “at least one of A and B”, or “at least one of A or B” may refer to all of the case (1) where at least one A is included, the case (2) where at least one B is included, or the case (3) where both of at least one A and at least one B are included.

The expressions such as “1st”, “2nd”, “first”, or “second”, and the like used in various embodiments of the present disclosure may refer to various elements irrespective of the order and/or priority of the corresponding elements, but do not limit the corresponding elements. The expressions may be used to distinguish one element from another element. For instance, both a first user device and a second user device indicate different user devices from each other irrespective of the order or priority of the corresponding elements. For example, a first component may be referred to as a second component and vice versa without departing from the scope of the present disclosure.

It will be understood that when an element (e.g., a first element) is referred to as being “(operatively or communicatively) coupled with/to” or “connected to” another element (e.g., a second element), it can be directly coupled with/to or connected to the other element or an intervening element (e.g., a third element) may be present. In contrast, when an element (e.g., a first element) is referred to as being “directly coupled with/to” or “directly connected to” another element (e.g., a second element), it should be understood that there are no intervening element (e.g., a third element) between the element and the other element.

Depending on the situation, the expression “configured to” used herein may be used as, for example, the expression “suitable for”, “having the capacity to”, “designed to”, “adapted to”, “made to”, or “capable of”. The term “configured to” should not mean only “specifically designed to” hardwarily. Instead, under any situation, the expression “a device configured to” may mean that the device is “capable of” operating together with another device or other components. For example, a “processor configured to perform A, B, and C” may mean a generic-purpose processor (e.g., a central processing unit (CPU) or an application processor) which may perform corresponding operations by executing one or more software programs which stores a dedicated processor (e.g., an embedded processor) for performing a corresponding operation.

Terms used in this specification are used to describe specified embodiments of the present disclosure and are not intended to limit the scope of the present disclosure. The terms of a singular form may include plural forms unless otherwise specified. Unless otherwise defined herein, all the terms used herein, which include technical or scientific terms, may have the same meaning that is generally understood by a person skilled in the art. It will be further understood that terms, which are defined in a dictionary and commonly used, should also be interpreted as is customary in the relevant related art and not in an idealized or overly formal detect unless expressly so defined herein in various embodiments of the present disclosure. In some cases, even if terms are terms which are defined in the specification, they may not be interpreted to exclude embodiments of the present disclosure.

Electronic devices according to various embodiments of the present disclosure may include at least one of, for example, smartphones, tablet personal computers (PCs), mobile phones, video telephones, electronic book readers, desktop PCs, laptop PCs, netbook computers, workstations, servers, personal digital assistants (PDAs), portable multimedia players (PMPs), Motion Picture Experts Group (MPEG-1 or MPEG-2) Audio Layer 3 (MP3) players, mobile medical devices, cameras, or wearable devices (e.g., smart glasses, head-mounted-devices (HMDs), an electronic apparel, electronic bracelets, electronic necklaces, electronic appcessories, electronic tattoos, smart mirrors, or smart watches).

According to various embodiments of the present disclosure, the electronic devices may be smart home appliances. The smart home appliances may include at least one of, for example, televisions (TVs), digital versatile disk (DVD) players, audios, refrigerators, air conditioners, cleaners, ovens, microwave ovens, washing machines, air cleaners, set-top boxes, home automation control panels, security control panels, TV boxes (e.g., SAMSUNG HOMESYNC™, APPLE TV™, or GOOGLE TV™), game consoles (e.g., XBOX™ and PLAYSTATION™), electronic dictionaries, electronic keys, camcorders, or electronic picture frames.

According to various embodiments of the present disclosure, the electronic devices may include at least one of various medical devices (e.g., various portable medical measurement devices (e.g., blood glucose meters, heart rate meters, blood pressure meters, or thermometers, and the like), a magnetic resonance angiography (MRA), a magnetic resonance imaging (MRI), a computed tomography (CT), scanners, or ultrasonic devices, and the like), navigation devices, global positioning system (GPS) receivers, event data recorders (EDRs), flight data recorders (FDRs), vehicle infotainment devices, electronic equipment for vessels (e.g., navigation systems, gyrocompasses, and the like), avionics, security devices, head units for vehicles, industrial or home robots, automatic teller's machines (ATMs), points of sales (POSs), or interne of things (e.g., light bulbs, various sensors, electric or gas meters, sprinkler devices, fire alarms, thermostats, street lamps, toasters, exercise equipment, hot water tanks, heaters, boilers, and the like).

According to various embodiments of the present disclosure, the electronic devices may include at least one of parts of furniture or buildings/structures, electronic boards, electronic signature receiving devices, projectors, or various measuring instruments (e.g., water meters, electricity meters, gas meters, or wave meters, and the like). According to various embodiments of the present disclosure, the electronic devices may be one or more combinations of the above-mentioned devices. The electronic devices according to various embodiments of the present disclosure may be flexible electronic devices. Also, the electronic devices according to various embodiments of the present disclosure are not limited to the above-mentioned devices, and may include new electronic devices according to technology development

Hereinafter, the electronic devices according to various embodiments of the present disclosure will be described with reference to the accompanying drawings. The term “user” used herein may refer to a person who uses an electronic device or may refer to a device (e.g., an artificial electronic device) which uses an electronic device.

Information values have become more important than material values as the 21th century has been called an information-oriented age. Recently, because a quantity, period, and form in which data are generated has been increased as digital environments have been expanded, big data, which are difficult to be collected, stored, searched for, and analyzed by conventional methods, have become important as a social issue. Therefore, a process of processing and analyzing data and generating significant data has become more and more important. Also, a process of providing analyzed data to users in a more efficient way has been gradually important.

Data search methods for processing and analyzing big data and providing the analyzed big data to users are provided. A data search method can include integrating and storing a variety of data in a data warehouse to use information in an efficient way, processing the stored data to correspond to specific purposes, and providing specific data to users according to previously defined rules or search items when they request the data.

In the above-mentioned data search method, users can access data in only a previously defined way and may not receive data in a way which is not previously defined. Also, for developers to provide new search items, an additional time or cost may be consumed. Therefore, there is a need for an electronic device, a search server, and a data search method therefor, which can set a search item which is not previously defined and can dynamically search for data.

FIG. 1 is a drawing illustrating an example configuration of a search system according to this disclosure. Referring to FIG. 1, a search system 1000 includes an electronic device 100, a search server 200, and a database (DB) server 300. Referring to FIG. 1, the electronic device 100, the search server 200, and the DB server 300 connects and communicates with each other over a network 10. For example, the electronic device 100, the search server 200, and the DB server 300 connects with each other through the Internet network. The electronic device 100 receives an index for setting a search item. According to an embodiment of the present disclosure, the electronic device 100 receives a plurality of indices for setting a search item. The search server 200 plays a role as middleware which allows a user of the electronic device 100 to easily access the DB server 300.

According to an embodiment of the present disclosure, the search server 200 sets a search item. According to an embodiment of the present disclosure, the search server 200 receives a plurality of indices for setting a search item from the electronic device 100 and analyzes link relations among the plurality of indices. According to an embodiment of the present disclosure, the search server 200 detects at least one path including the plurality of indices. According to an embodiment of the present disclosure, the search server 200 selects one of the at least one detected path and sets a search item according to the selected path. For example, the search server 200 sets a search item according to a path selected by the user among the at least one detected path.

According to an embodiment of the present disclosure, the search server 200 generates a query according to the set search item. The search server 200 transmits the generated query to the DB server 300. According to an embodiment of the present disclosure, the DB server 300 includes a DB. According to an embodiment of the present disclosure, the DB stores various types of raw data as an integrated type of data. According to an embodiment of the present disclosure, the DB is a relational DB (RDB). According to an embodiment of the present disclosure, the DB server 300 searches for data according to the query received from the search server 200. The DB server 300 transmits the found result (or the found data) to the search server 200.

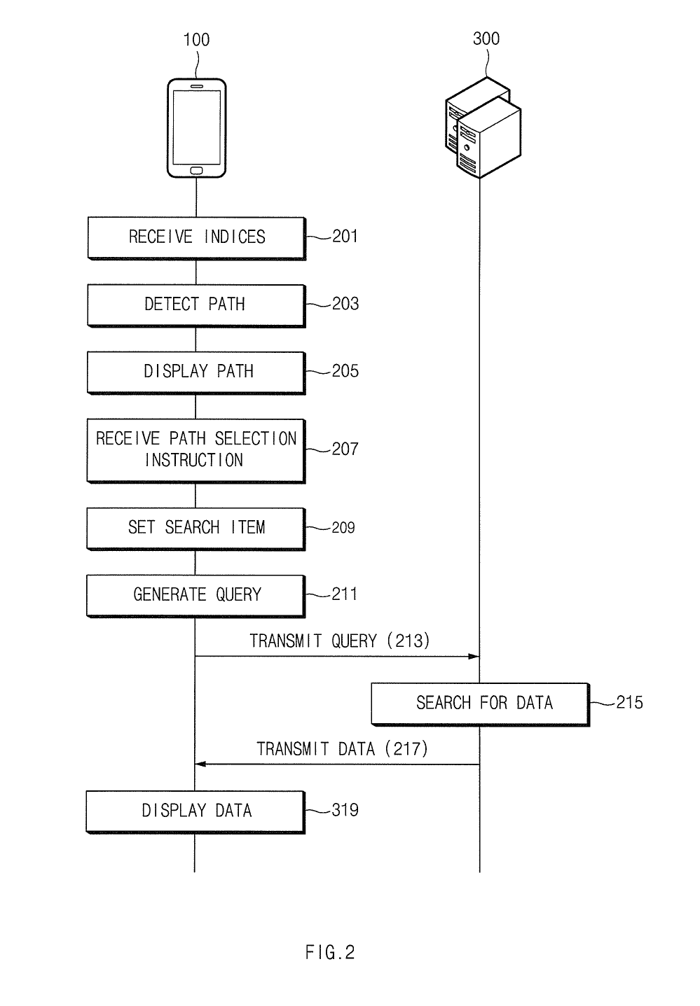

FIG. 2 is a signal sequence diagram illustrating an example data search method of a search system according to this disclosure. Referring to FIG. 2, in operation 201, an electronic device 100 receives a plurality of indices from a user. In operation 203, the electronic device 100 detects a path according to the plurality of input indices. According to an embodiment of the present disclosure, the electronic device 100 detects at least one path, including the plurality of indices, using an index map in which link relations among a plurality of indices are defined. According to an embodiment of the present disclosure, the electronic device 100 detects a path which has the plurality of indices as endpoints.

In operation 205, the electronic device 100 displays the at least one detected path. According to an embodiment of the present disclosure, the electronic device 100 displays the at least one detected path as a list shape. According to an embodiment of the present disclosure, the electronic device 100 displays link relations among the plurality of indices included in the path. According to an embodiment of the present disclosure, the electronic device displays the number of the indices included in the path or the number of links among the indices included in the path. In operation 207, the electronic device 100 receives a path selection instruction from the user. According to an embodiment of the present disclosure, the electronic device 100 receives a user instruction to select one of paths received from a search server 200 of FIG. 1.

In operation 209, when receiving the path selection instruction, the electronic device 100 sets a search item according to the selected path. According to an embodiment of the present disclosure, the electronic device 100 sets a plurality of indices, included in the selected path, to a search item. In operation 211, the electronic device 100 generates a query according to the search item and relation information among a plurality of indices included in the search item. According to an embodiment of the present disclosure, the electronic device 100 generates a SPARQL protocol and resource description framework (RDF) query language (SPARQL) query. According to an embodiment of the present disclosure, the electronic device 100 converts a SPARQL query into a structure query language (SQL) query according to an RDB to RDF mapping rule. In operation 213, the electronic device 100 transmits the generated query to the DB server 300.

In operation 215, the DB server 300 searches for data using the query received from the electronic device 100. In operation 217, the DB server 300 transmits the found data to the electronic device 100. In operation 219, the electronic device 100 displays the data received from the DB server 300. According to various embodiments of the present disclosure, some of the operations performed by the electronic device 100 are performed by the search server 200.

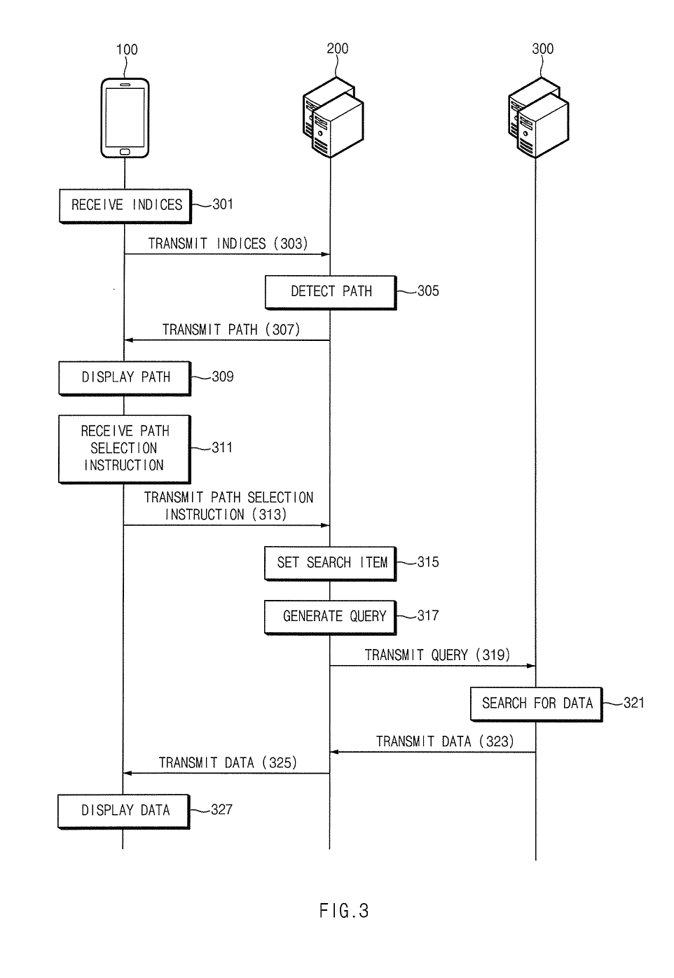

FIG. 3 is a signal sequence diagram illustrating an example data search method of a search system according to this disclosure. FIG. 3 illustrates an example in which some of operations performed by an electronic device 100 in a data search method shown in FIG. 2 are performed by a search server 200. Referring to FIG. 3, in operation 301, the electronic device 100 receives a plurality of indices from its user.

In operation 303, the electronic device 100 transmits the received indices to the search server 200. In operation 305, the search server 200 detects a path according to the plurality of indices received from the electronic device 100. According to an embodiment of the present disclosure, the search server 200 detects at least one path, including the plurality of received indices, using an index map in which link relations among a plurality of indices are defined. According to an embodiment of the present disclosure, the search server 200 detects a path which has the plurality of indices as endpoints.

In operation 307, the search server 200 transmits the at least one detected path to the electronic device 100. In operation 309, the electronic device 100 displays the at least one path received from the search server 200. According to an embodiment of the present disclosure, the electronic device 100 displays the at least one path received from the search server 200 as a list shape. According to an embodiment of the present disclosure, the electronic device 100 displays link relations among the plurality of indices included in the path. According to an embodiment of the present disclosure, the electronic device 100 displays the number of the indices included in the path or the number of links among the indices included in the path.

In operation 311, the electronic device 100 receives a path selection instruction from the user. According to an embodiment of the present disclosure, the electronic device 100 receives a user instruction to select one of the at least one path received from the search server 200. In operation 313, the electronic device 100 transmits the path selection instruction to the search server 200. In operation 315, when receiving the path selection instruction, the search server 200 sets a search item according to the selected path. According to an embodiment of the present disclosure, the search server 200 sets a plurality of indices, included in the selected path, to a search item.

In operation 317, the search server 200 generates a query according to the search item and relation information among the plurality of indices included in the search item. According to an embodiment of the present disclosure, the search server 200 generates a SPARQL query. According to an embodiment of the present disclosure, the search server 200 converts a SPARQL query into an SQL query according to an RDB to RDF mapping rule. In operation 319, the search server 200 transmits the generated query to the DB server 300. In operation 321, the DB server 300 searches for data using the query received from the search server 200. In operation 323, the DB server 300 transmits the found data to the search server 200. In operation 325, the search server 200 transmits the data received from the DB server 300 to the electronic device 100. In operation 327, the electronic device 100 displays the data received from the search server 200.

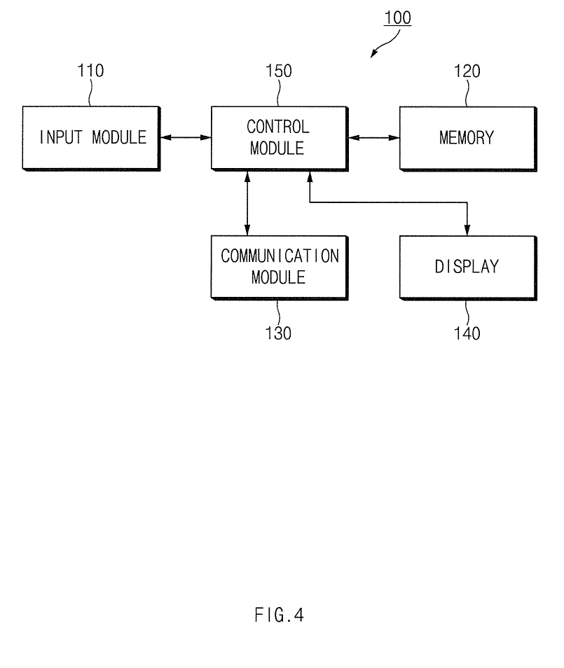

FIG. 4 is a block diagram illustrating an example configuration of an electronic device according to this disclosure. Referring to FIG. 4, an electronic device 100 includes an input module 110, a memory 120, a communication module 130, a display module 140, and a control module 150. The input module 110 receives a user instruction (or a user operation). According to an embodiment of the present disclosure, the input module 110 receives a plurality of indices from a user of the electronic device 100. According to an embodiment of the present disclosure, the input module 110 receives a user instruction to select at least one of detected paths. According to an embodiment of the present disclosure, the input module 110 receives a user instruction to store a search item. According to an embodiment of the present disclosure, the input module 110 receives a user instruction to add a new index to a search item.

The input module 110 includes at least one of a touch screen or touch pad which operates by a touch input of the user, a key pad or key board which has various function keys, numeric keys, special keys, character keys, and the like, a remote controller, a mouse, a motion sensor which recognizes motion of the user, or a voice sensor which recognizes a voice of the user. The memory 120 stores an index map (or, relation information among indices). The index map includes information about link relations among a plurality of indices. According to an embodiment of the present disclosure, the memory 120 stores a search item.

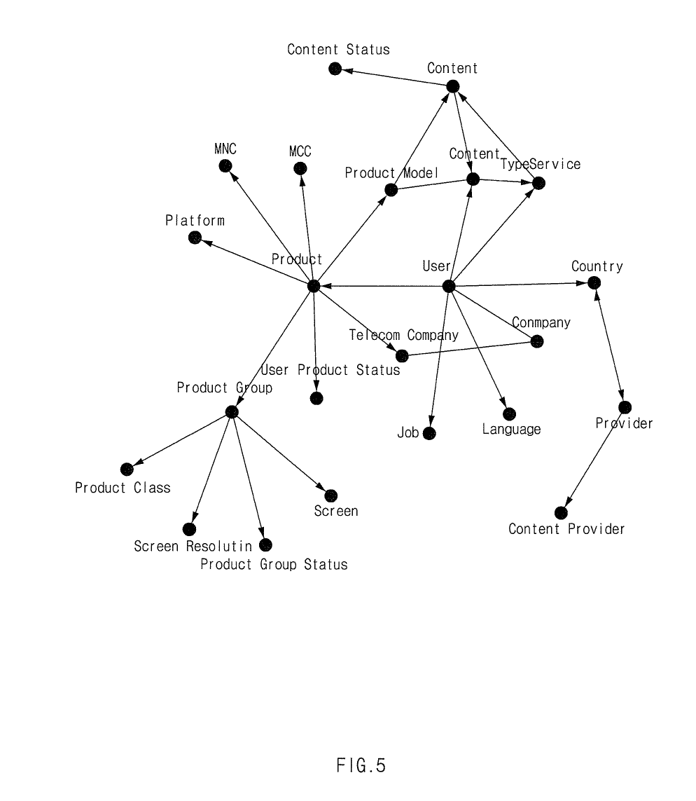

FIG. 5 is a drawing illustrating an example index map according to this disclosure. An index which is the standard of classifying or integrating data has a correlation with at least one another index. According to an embodiment of the present disclosure, an index map includes a plurality of indices and information about link relations among the plurality of indices. According to an embodiment of the present disclosure, the index map includes information about whether there are links among a plurality of indices. For example, an index ‘user’ is linked with indices ‘country’, ‘company’, ‘language’, ‘job’, ‘product’, and ‘content type’. Linked indices have directivity in one or two ways according to link relations. According to an embodiment of the present disclosure, the index map includes information link relations among a plurality of indices. For example, a link relation between the indices ‘user’ and ‘service’ is defined as “user ‘use’ service”. A link relation between the indices service' and ‘content’ is defined as “service ‘provides’ content”. A link relation between the indices ‘user’ and ‘product’ is defined as “user ‘owns’ product”.

A communication module 130 of FIG. 4 communicates with a search server 200 or a DB server 300 of FIG. 1 and transmits and receives a variety of information, necessary for searching for data, and found data. According to an embodiment of the present disclosure, the communication module 130 transmits a query generated by a control module 150 of FIG. 4 to the DB server 300. According to an embodiment of the present disclosure, the communication module 130 receives found data from the DB server 300.

A display 140 of FIG. 4 displays information, necessary for searching for data, and found data. According to an embodiment of the present disclosure, the display 140 displays a field for receiving an index. According to an embodiment of the present disclosure, the display 140 displays at least one path detected according to a plurality of indices entered from a user. According to an embodiment of the present disclosure, the display 140 displays a plurality of indices included in a path and link relations among the plurality of indices.

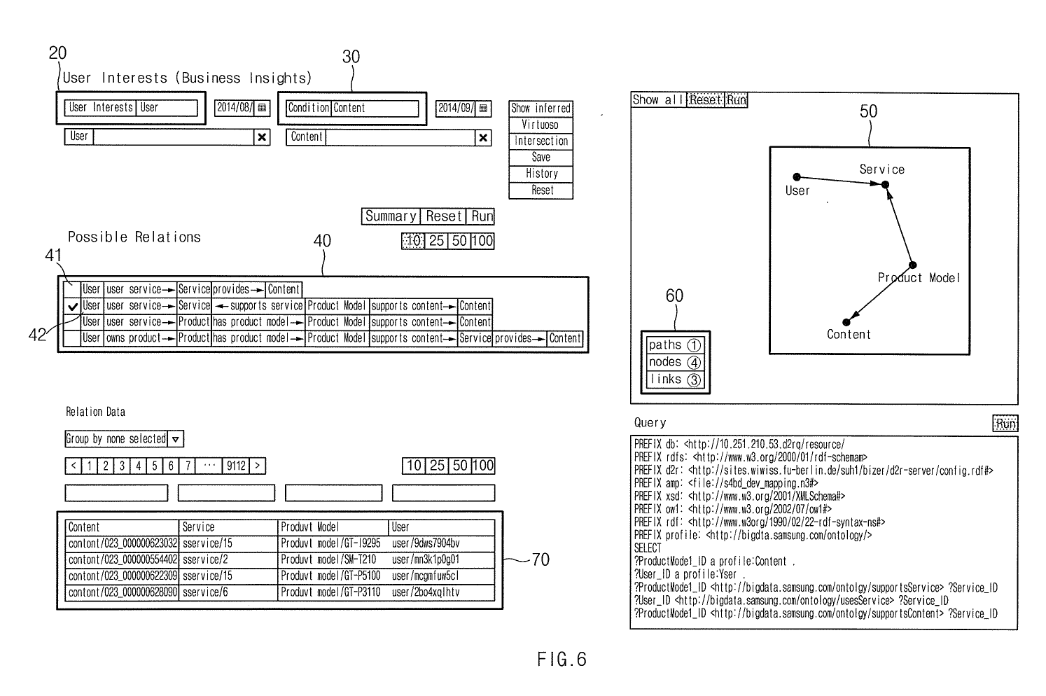

According to an embodiment of the present disclosure, when at least one of detected paths is selected, the display 140 displays link relations, among a plurality of indices included in the selected path, as an image object. According to an embodiment of the present disclosure, the display 140 displays the number of paths selected by the user, the number of indices included in the selected path, or the number of links among the indices included in the selected path. A description will be given in detail for information displayed on the display 140 with reference to FIG. 6.

FIG. 6 is a drawing illustrating an example display screen according to this disclosure. According to an embodiment of the present disclosure, a display 140 of FIG. 4 displays fields 20 and 30 for receiving indices. For example, referring to FIG. 6, the display 140 displays a first field 20 for receiving an index which is a search goal and a second field 30 which receives an index which is a search condition. A user sets a search item by entering indices in the plurality of fields 20 and 30. For example, the user enter an index ‘user’ in the first field 20 and enters an index ‘content’ in the second field 30 to search for ‘the number of users who use a specific content’.

According to an embodiment of the present disclosure, the display 140 displays at least one path 40 detected according to a plurality of indices entered by the user. For example, referring to FIG. 6, the display 140 displays the at least one path 40, detected according to the indices ‘user’ and ‘content’ entered by the user, as a list shape. According to an embodiment of the present disclosure, the display 140 displays a plurality of indices included in the at least one path 40 and link relations among the plurality of indices. For example, the display 140 displays indices ‘user’, ‘service’, and ‘content’ included in a first path 41 among the at least one path 40 of the list shape and displays a link relation “user ‘use’ service” between the indices ‘user’ and ‘service’ and a link relation “service ‘provides’ content” between the indices ‘service’ and ‘content’.

According to an embodiment of the present disclosure, when at least one of the at least one displayed path is selected, the display 140 displays link relations, among a plurality of indices included in the selected path, as an image object. For example, when a second path 42 of the at least one path 40 of the list shape shown in FIG. 6 is selected, the display 140 displays an image object 50 indicating link relations among the indices ‘user’, ‘service’, ‘product model’, and ‘content’ included in the selected path 42.

According to an embodiment of the present disclosure, the display 140 displays detailed information about the selected path. For example, the display 140 displays the number of the selected path, the number of indices included in the path, or the number of links among the indices included in the path. For example, referring to FIG. 6, the display 140 displays detailed information 60 which includes the number (paths) of a selected path, the number (nodes) of indices included in the path, and the number (links) of links among the indices included in the path.

According to an embodiment of the present disclosure, when data are received from a DB server 300 of FIG. 1, the display 140 displays the received data. For example, referring to FIG. 6, the display 140 displays received data 70 as a list shape. A control module 150 of FIG. 4 controls an overall operation of an electronic device 100 of FIG. 4. According to an embodiment of the present disclosure, when a plurality of indices are entered from the user, the control module 150 detects at least one path, including the plurality of indices, using an index map stored in a memory 120 of FIG. 4. For example, the control module 150 detects a path which has the plurality of entered indices as endpoints. According to an embodiment of the present disclosure, when a user instruction to select at least one of the at least one detected path is entered, the control module 150 sets a search item according to the selected path. For example, the control module 150 sets a plurality of indices, included in a path selected by the user, to a search item.

According to an embodiment of the present disclosure, when a user instruction to add a new index to the set search item is entered, the control module 150 detects a new path to which the new index is added. For example, when the user enters a new index in the second field 30 shown in FIG. 6, the control module 150 detects an additional path including the new index.

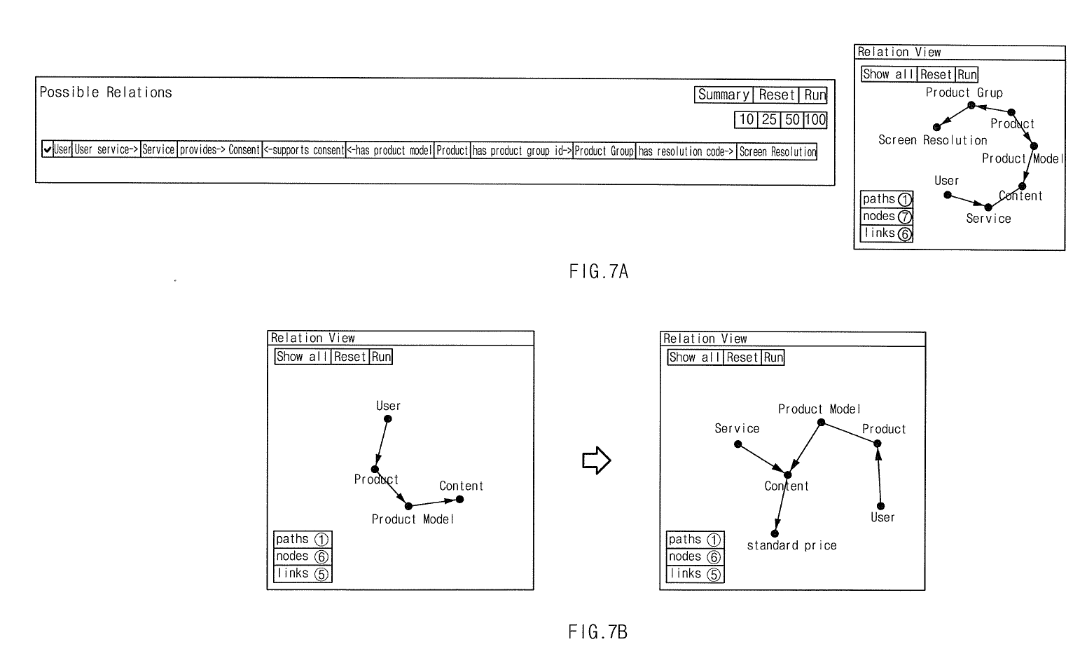

FIGS. 7A and 7B are drawings illustrating an example display screen according to this disclosure. According to an embodiment of the present disclosure, when a user instruction to add a new index to a set search item is entered, a control module 150 of FIG. 4 detects a new path to which the new index is added. For example, when a new index ‘screen resolution’ is entered in a second field 30 in a state where a second path 42 of paths shown in FIG. 6 is selected, the control module 150 detects a path including indices ‘user’, ‘content’, and ‘screen resolution’. FIG. 7A illustrates the result of detecting the new path including the indices ‘user’, ‘content’, and ‘screen resolution’.

According to an embodiment of the present disclosure, a user changes a set search item. For example, the user adds a new index, linked with a specific index included in a set search item, to the set search item. Alternatively, the user deletes some of indices included in a search item. Referring to FIG. 7B, new indices ‘service’ and ‘standard price’ linked with an index ‘content’ is added in a search item including indices ‘user’, ‘product’, ‘product model’, and ‘content’. Therefore, the user may more conveniently and freely set a search item. According to an embodiment of the present disclosure, the control module 150 generates a query according to a set search item and link information among a plurality of indices included in the search item. According to an embodiment of the present disclosure, the control module 150 generates a SPARQL query. According to an embodiment of the present disclosure, the control module 150 converts a SPARQL query into an SQL query according to an RDB to RDF mapping rule.

According to an embodiment of the present disclosure, at least some of operations performed in the control module 150 are performed in a search server 200 of FIG. 1. According to various embodiments of the present disclosure, the electronic device includes an input module configured to receive a plurality of indices for setting a search item, a memory configured to store an index map in which link relations among a plurality of indices are defined, and a control module configured to detect at least one path, including the plurality of received indices, using the index map and to set the search item according to the detected path.

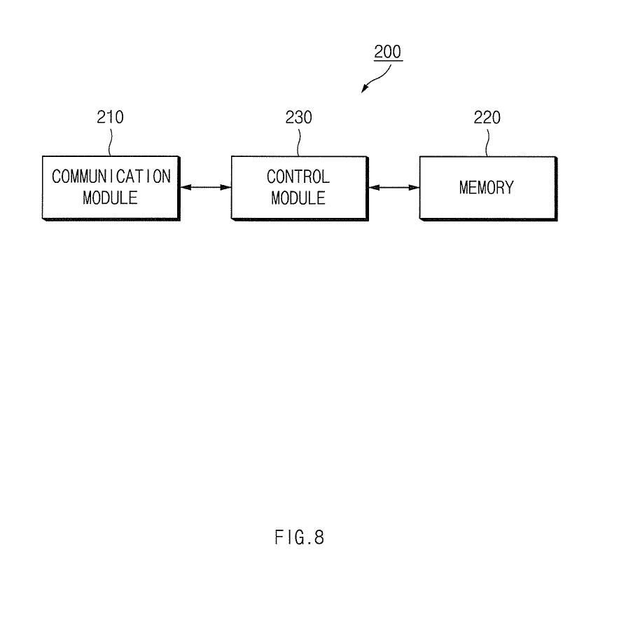

FIG. 8 is a block diagram illustrating an example configuration of a search server according to this disclosure. Referring to FIG. 8, a search server 200 includes a communication module 210, a memory 220, and a control module 230. The communication module 210 communicates with an electronic device 100 of FIG. 4 or a DB server 300 of FIG. 1 and transmits and receives a variety of information, necessary for searching for data, and found data. According to an embodiment of the present disclosure, the communication module 210 receives a user instruction entered in the electronic device 100. According to an embodiment of the present disclosure, the communication module 210 transmits a query generated by the control module 230 to the DB server 300. According to an embodiment of the present disclosure, the communication module 210 receives found data from the DB server 300. According to an embodiment of the present disclosure, the communication module 210 transmits data received from the DB server 300 to the electronic device 100. The memory 220 stores an index map (or relation information among indices). The index map includes information about link relations among a plurality of indices. According to an embodiment of the present disclosure, the memory 220 stores a search item.

An index which is the standard of classifying or integrating data has a correlation with at least one another index. According to an embodiment of the present disclosure, an index map includes a plurality of indices and information about link relations among the plurality of indices. According to an embodiment of the present disclosure, the index map includes information about whether there are links among a plurality of indices. For example, an index ‘user’ is linked with indices ‘country’, ‘company’, ‘language’, ‘job’, ‘product’, and ‘content type’. Linked indices have directivity in one or two ways according to link relations. According to an embodiment of the present disclosure, the index map includes information link relations among a plurality of indices. For example, a link relation between the indices ‘user’ and ‘service’ is defined as “user ‘use’ service”. A link relation between the indices ‘service’ and ‘content’ is defined as “service ‘provides’ content”. A link relation between the indices ‘user’ and ‘product’ is defined as “user ‘owns’ product”.

The control module 230 controls an overall operation of the search server 200. According to an embodiment of the present disclosure, when a plurality of indices are received from the electronic device 100, the control module 230 detects at least one path, including the plurality of indices, using the index map stored in the memory 120. For example, the control module 230 detects a path which has the plurality of received indices as endpoints.

According to an embodiment of the present disclosure, when a user instruction to select at least one of the at least one detected paths is received from the electronic device 100, the control module 230 sets a search item according to the selected path. For example, the control module 230 sets a plurality of indices, included in a path selected by the user, to a search item. According to an embodiment of the present disclosure, the set search item is changed according to a user instruction. For example, the user adds a new index, linked with a specific index included in the set search item, to the set search item. Alternatively, the user deletes some indices included in the search item.

According to an embodiment of the present disclosure, when a user instruction to add a new index to the set search item is received from the electronic device 100, the control module 230 detects a new path to which the new index is added. According to an embodiment of the present disclosure, the control module 230 generates a query according to the set search item and relation information among a plurality of indices included in the search item. According to an embodiment of the present disclosure, the control module 230 generates a SPARQL query. According to an embodiment of the present disclosure, the control module 230 converts a SPARQL query into an SQL query according to an RDB to RDF mapping rule.

According to various embodiments of the present disclosure, the search server includes a communication module configured to receive a plurality of indices for setting a search item, a memory configured to store an index map in which link relations among a plurality of indices are defined, and a control module configured to detect at least one path, including the plurality of received indices, using the index map and to set the search item according to the detected path.

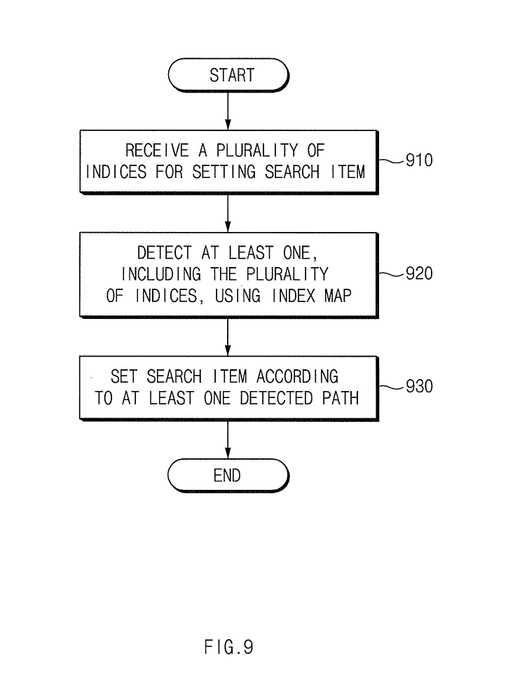

FIG. 9 is a flowchart illustrating an example data search method of an electronic device according to this disclosure. The data search method of the electronic device shown in FIG. 9 includes operations processed in an electronic device 100 shown in FIG. 4. Therefore, although there are contents omitted below, contents described about the electronic device 100 shown in FIG. 4 can be applied to the flowchart shown in FIG. 9.

Referring to FIG. 9, in operation 910, the electronic device 100 receives a plurality of indices for setting a search item. According to an embodiment of the prevent disclosure, the electronic device 100 displays a first field for receiving an index which is a search goal and a second field for receiving an index which is a search condition and receives a plurality of indices through the first field and the second field. In operation 920, the electronic device 100 detects at least one path, including the plurality of received indices, using an index map. For example, the electronic device 100 detects a path which has the plurality of received indices as endpoints. According to an embodiment of the prevent disclosure, the electronic device 100 displays the detected path. According to an embodiment of the prevent disclosure, the electronic device 100 displays a plurality of indices, included in the path, and link relations among the plurality of indices.

According to an embodiment of the prevent disclosure, when at least one of the at least one detected path is selected, the electronic device 100 displays link relations, among a plurality of indices included in the selected path, as an image object. According to an embodiment of the prevent disclosure, the electronic device 100 displays the number of paths selected by the user, the number of indices included in the selected paths, or the number of links among the indices included in the selected paths.

In operation 930, the electronic device 100 sets a search item according to the at least one detected path. According to an embodiment of the prevent disclosure, when a user instruction to select at least one of the at least one detected path is entered, the electronic device 100 sets a search item according to a path selected by the user. For example, the electronic device 100 sets a plurality of indices, included in a path selected by the user, to a search item. According to an embodiment of the prevent disclosure, the electronic device 100 changes the set search item according to a user instruction. For example, the user adds a new index, linked with a specific index included in the set search item, to the set search item. Alternatively, the user deletes some indices included in the search item.

According to an embodiment of the prevent disclosure, when a user instruction to add a new index to the set search time is entered, the electronic device 100 detects a new path to which the new index is added. According to an embodiment of the prevent disclosure, the electronic device 100 generates a query according to the set search item and relation information among a plurality of indices included in the search item. According to an embodiment of the prevent disclosure, the electronic device 100 generates a SPARQL query. According to an embodiment of the prevent disclosure, the electronic device 100 converts a SPARQL query into an SQL query according to an RDB to RDF mapping rule.

According to an embodiment of the prevent disclosure, the electronic device 100 transmits the generated query to a DB server 300 of FIG. 1. According to an embodiment of the prevent disclosure, when receiving data from the DB server 300, the electronic device 100 displays the received data. According to various embodiments of the prevent disclosure, the data search method includes receiving a plurality of indices for setting a search item, detecting at least one path, including the plurality of received indices, using an index map in which link relations among a plurality of indices are defined, and setting the search item according to the at least one detected path.

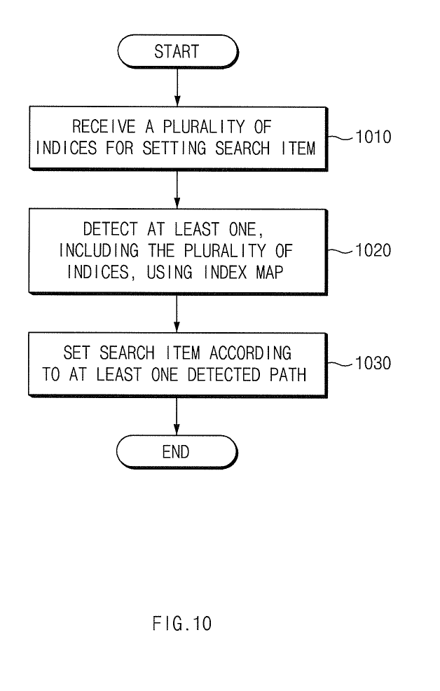

FIG. 10 is a flowchart illustrating a data search method of a search server according to various embodiments of the present disclosure. The data search method of the search server, shown in FIG. 10, includes operations processed in a search server 200 shown in FIG. 8. Therefore, although there are contents omitted below, contents described about the search server 200 shown in FIG. 8 can be applied to the flowchart shown in FIG. 10. Referring to FIG. 10, in operation 1010, the search server 200 receives a plurality of indices for setting a search item from an electronic device 100 of FIG. 4. In operation 1020, the search server 200 detects at least one path, including the plurality of received indices, using an index map. For example, the search server 200 detects a path which has the plurality of received indices as endpoints. According to an embodiment of the present disclosure, the search server 200 transmits the at least one detected path to the electronic device 100.

In operation 1030, the search server 200 set a search item according to the at least one detected path. According to an embodiment of the present disclosure, when a user instruction to select at least one of the at least one detected path is received from the electronic device 100, the search server 200 sets a search item according to a path selected by a user. For example, the search server 200 sets a plurality of indices, included in a path selected by the user, to a search item. According to an embodiment of the present disclosure, the search server 200 changes the set search item according to a user instruction received from the electronic device 100. For example, the user adds a new index, linked with a specific index included in the set search item, to the set search item. Alternatively, the user deletes some of indices included in the search item.

According to an embodiment of the present disclosure, when a user instruction to add a new index to the set search item is received from the electronic device 100, the search server 200 detects a new path to which the new index is added. According to an embodiment of the present disclosure, the search server 200 generates a query according to the set search item and relation information among a plurality of indices included in the search item. According to an embodiment of the present disclosure, the search server 200 generates a SPARQL query. According to an embodiment of the present disclosure, the search server 200 converts a SPARQL query into an SQL query according to an RDB to RDF mapping rule.

According to an embodiment of the present disclosure, the search server 200 transmits the generated query to a DB server 300 of FIG. 1. According to an embodiment of the present disclosure, when receiving data from the DB server 300, the search server 200 transmits the received data to the electronic device 100. According to various embodiments of the present disclosure, the data search method includes receiving a plurality of indices for setting a search item, detecting at least one path, including the plurality of received indices, using an index map in which link relations among a plurality of indices are defined, and setting the search item according to the at least one detected path. According to various embodiments of the present disclosure, the data search method of the electronic device or the search server is implemented with a program which is executable in the electronic device. This program is stored and used in various types of recording media.

Specifically, program codes for performing the above-mentioned methods may be stored in various types of non-volatile recording media, such as a flash memory, a read only memory (ROM), an erasable programmable ROM (EPROM), an electronically erasable and programmable ROM (EEPROM), a hard disc, a removable disc, a memory card, a universal serial bus (USB) memory, and a compact disc-ROM (CD-ROM). According to various embodiments of the present disclosure, the electronic device may immediately reflect new business insight by setting a search item which is not previously defined. Also, although the user of the electronic device does not know relation information among indices which are difficult to understand, the electronic device may conveniently ascertain relation information among specific indices.

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. A search server, comprising:
a communication device configured to receive a plurality of indices for setting a search item;
a memory configured to store an index map in which link relations among a plurality of indices are defined; and
a controller configured to:
detect at least one path, including the plurality of received indices, using the index map, and
set the search item according to the at least one detected path.

2. The search server of claim 1, wherein the controller is configured to detect a path that has the plurality of received indices as endpoints.

3. The search server of claim 1, wherein when a user instruction to select at least one of the at least one detected path is received, the controller is configured to set a plurality of indices, included in a path selected by a user, to the search item.

4. The search server of claim 1, wherein when a user instruction to add a new index to the set search item is received, the controller is configured to detect a new path to which the new index is added.

5. The search server of claim 1, wherein the controller is configured to generate a query according to the set search item and relation information among a plurality of indices included in the search item and transmit the generated query to a database (DB) server.

6. A data search method, comprising:
receiving a plurality of indices for setting a search item;
detecting at least one path, including the plurality of received indices, using the index map in which link relations among a plurality of indices are defined; and
setting the search item according to the at least one detected path.

7. The data search method of claim 6, wherein detecting the at least one path comprises:
detecting a path that has the plurality of received indices as endpoints.

8. The data search method of claim 6, wherein setting the search item comprises:
setting a plurality of indices, included in a path selected by a user among the at least one detected path, to the search item.

9. The data search method of claim 6, further comprising:
receiving a user instruction to add a new index to the set search item; and
detecting a new path to which the new index is added.

10. The data search method of claim 6, further comprising:
generating a query according to the set search item and relation information among a plurality of indices included in the search item; and
transmitting the generated query to a database (DB) server.

11. An electronic device, comprising:
an input device configured to receive a plurality of indices for setting a search item;
a memory configured to store an index map in which link relations among a plurality of indices are defined; and
a controller configured to:
detect at least one path, including the plurality of received indices, using the index map, and
set the search item according to the at least one detected path.

12. The electronic device of claim 11, wherein the controller is configured to detect a path that has the plurality of received indices as endpoints.

13. The electronic device of claim 11, further comprising:
a display configured to display the at least one detected path.

14. The electronic device of claim 13, wherein the display is configured to display link relations among a plurality of indices included in the at least one detected path.

15. The electronic device of claim 13, wherein the display is configured to display the number of selected paths, the number of indices included in the paths, or the number of links among the indices included in the paths.

16. The electronic device of claim 11, wherein when a user instruction to select at least one of the at least one detected path is received, the controller is configured to set a plurality of indices, included in a path selected by a user, to the search item.

17. The electronic device of claim 11, wherein when a user instruction to add a new index to the set search item is received, the controller is configured to detect a new path to which the new index is added.

18. The electronic device of claim 11, wherein the controller is configured to generate a query according to the set search item and relation information among a plurality of indices included in the search item and transmit the generated query to a database (DB) server.

19. A data search method, comprising:
receiving a plurality of indices for setting a search item;
detect at least one path, including the plurality of received indices, using an index map in which link relations among a plurality of indices are defined; and
setting the search item according to the at least one detected path.

20. The data search method of claim 19, wherein detecting the at least one path comprises:
detecting a path that has the plurality of received indices as endpoints.
